(19) United States
(12) Patent Application Publication
(10) Pub. No.: US 2020/0189455 A1
(43) Pub. Date: Jun. 18, 2020

(54) VEHICLE WITH A DEVICE FOR PROVIDING INFORMATION TO A USER OF A VEHICLE, BY PROJECTING ONE OR MORE IMAGES ONTO THE GROUND

(71) Applicant: PSA Automobiles SA, Poissy (FR)

(72) Inventors: Jean Charles BERREUR, Villejuif (FR); Ivan JACQUEMARD, Issy les Moulineaux (FR)

(21) Appl. No.: 16/611,136

(22) PCT Filed: Apr. 10, 2018
(86) PCT No.: PCT/FR2018/050901

§ 371 Date: Nov. 5, 2019

(30) Foreign Application Priority Data
May 10, 2017 (FR) 1754069

(51) Int. Cl. B60Q 1/52; B60Q 1/32

(52) U.S. Cl. CPC B60Q 1/52; B60Q 2400/50; B60Q 2400/40; B60Q 1/323

(57) ABSTRACT

A device for providing information (DF) is fitted to a land vehicle (V) and comprises a communication module (MCN) connected to a wireless communication network (RC). This device (DF) comprises projection means (MP1-MP3) that are installed in at least one portion (PLI, PL2, PR) of the vehicle (V) and are able to project at least one image onto the ground, and control means (MCT) determining, from items of information received from the wireless communication network (RC) by the communication module (MCN), when a detected person is about to access the vehicle (V), whether some of these items of information relate to this detected person and, if so, triggering the projection, by the projection means (MP1-MP3), of at least one image representative of these determined items of information onto the ground in immediate proximity to at least one zone (ZI) allowing access to the vehicle (V).

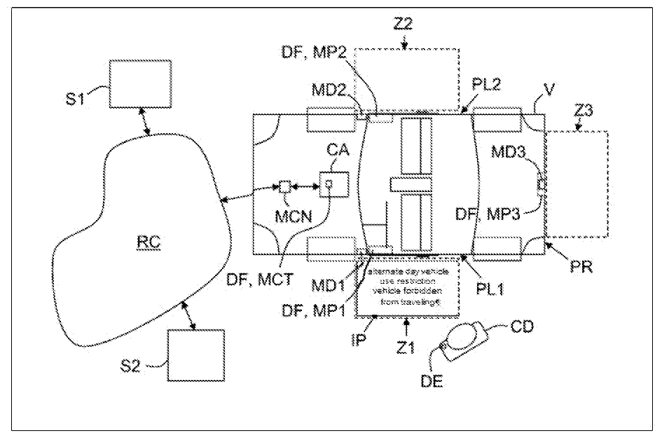

### CROSS-REFERENCE TO RELATED APPLICATIONS

This application is the US National Stage under 35 USC § 371 of International Application No. PCT/FR2018/050901, filed 10 Apr. 2018 which claims priority to French Application No. 1754069 filed 10 May 2017, both of which are incorporated herein by reference.

### BACKGROUND

The invention relates to devices which are intended for providing information to a person wishing to access a terrestrial vehicle.

As a person skilled in the art knows, and as is in particular described in US Pub. No. 2016/207448, some terrestrial vehicles, generally cars, comprise a projection device responsible for projecting an image onto the ground. More precisely, the image is projected onto a zone that is located beside a side door that has just been opened, in order to alert people located outside the vehicle that there is a possibility that at least one passenger may exit the vehicle. The projected image comprises, for example, a single drawing that is representative of a person or of an exclamation mark (“!”).

This type of provision of information is intended exclusively for people located outside the vehicle, in order to make it safe for passengers to exit. It is therefore not at all intended that information should be provided to a person, and in particular the driver, before he or she accesses the vehicle, for example with the aim of alerting the person to a traffic problem or to an alternate day vehicle use restriction, or even to difficult weather conditions.

### SUMMARY

The invention in particular aims to improve the situation.

For this purpose, an information provision device is proposed which is intended for a terrestrial vehicle and comprises a communications module connected to a wireless communications network, and which also comprises projection means that is suitable for being installed in at least a part of the vehicle and for projecting at least one image onto the ground in the vicinity of the vehicle.

The device comprises control means which determines, from the information received by the communications module from the wireless communications network, when a detected person is preparing to access the vehicle, whether some of the information concerns the detected person and, if so, triggers the projection, by the projection means, of at least one image representative of the determined information onto the ground in the immediate vicinity of at least one zone that allows for access to the vehicle.

By virtue of the device, it is henceforth possible to alert a detected person to a problem or event concerning the person, just before they access the vehicle.

The device may have other characteristics which can be taken separately or in combination, in particular:
the projection means thereof may comprise at least one first mini-projector that is suitable for being installed in a first side part of the vehicle that is suitable for projection into a zone allowing for access to a driver's position of the vehicle;
   the projection means thereof may comprise a second mini-projector that is suitable for being installed in a second side part of the vehicle that is suitable for projection into a zone allowing for access to a front passenger seat of the vehicle, and/or a third mini-projector that is suitable for being installed in a rear part of the vehicle that is suitable for projection into a rear zone allowing for access to an object storage space of the vehicle;
the control means thereof can determine the information that is likely to hinder or prevent driving of the vehicle;
the determined information thereof may be selected from road information, meteorological information, pollution information, a receipt of an electronic message, and a receipt of an audio message of a telephone voicemail;
   the road information (including alternate day vehicle use restrictions), meteorological information and pollution information may relate to a pre-programmed route that the vehicle is preparing to take;
the control means thereof may trigger the projection of one or more images in the event of receipt of a dedicated general message by the detection means of the vehicle, in the event of detection of a person close to the vehicle.

A terrestrial vehicle, possibly of the automobile type, is also proposed which comprises a communications module that is connected to a wireless communications network, and an information provision device such as described above.

When the vehicle is of the automobile type, it may comprise a rocker panel to which the projection means of the information provision device thereof is rigidly connected.

### DESCRIPTION OF THE FIGURE

Other features and advantages of the device and vehicle will become clear from reading the following detailed description, and from the accompanying drawing in which the single FIGURE is a schematic and functional plan view of a vehicle equipped with a communications module and connected to a wireless communications network, and from an embodiment of an information provision device according to the invention.

### DETAILED DESCRIPTION

An information provision device DF is proposed which is intended for use with a terrestrial vehicle V, which is connected to a wireless communications network RC, and which is adapted to project onto the ground at least one informational image IP that is intended for a person CD who is detected and is preparing to access the vehicle V.

In the following, it will be assumed, by way of non-limiting example, that the vehicle V is a car. However, the device DF is not limited to this type of vehicle. Indeed, the device DF relates to any type of terrestrial vehicle that is connected to a wireless communications network and can accommodate at least one person. Thus, the device DF can also, and in particular, be used with utility vehicles, motorcycles, bicycles, coaches (or buses), trucks, construction vehicles, agriculture vehicles, and refuse collection vehicles.

The single FIGURE schematically shows a terrestrial vehicle V (in this case a car) that comprises a communications module MCN and an information provision device DF.

The communications module MCN is connected to at least one wireless communications network RC, for example of the 4G type. As a result, the vehicle V is said to be connected, because it can receive information provided by at least one information server or information site Sn that is connected, directly or indirectly, to the wireless communications network RC, when it is operating or on standby.

As shown in the single FIGURE, an information provision device DF comprises at least projection means MPj and control means MCT.

The projection means MPj is suitable for being installed in at least one part PLj of the vehicle V and for projecting, on demand, at least one image onto the ground, in the immediate vicinity of at least one zone Zj that allows for access to the vehicle V.

For example, the projection means MPj may be installed in a rocker panel of the vehicle V. However, it could also be installed in an outside rearview mirror of the vehicle V or in a front or rear bumper of the vehicle V, or even on a side edge of the roof or body roof of the vehicle V.

Also for example, and as illustrated in a non-limiting manner in the single drawing, the projection means MPj may comprise at least one first mini-projector MP1 (j=1) that is suitable for being installed in a first side part PL1 of the vehicle V that is suitable for projection into a zone Z1 allowing for access to a driver's position of the vehicle V. In this case “mini-projector” is understood to be a miniature video projector of the pico projector type (optionally LED), such as those which are used in some mobile telephones.

In this case, the mini-projector MP1 is installed on a left-hand side member of the vehicle V which is positioned beside the driver's position, comprising the driver's seat and the steering wheel.

Also for example, and as illustrated in a non-limiting manner in the single drawing, the projection means MPj may comprise, in addition, a second mini-projector MP2 that is suitable for being installed in a second side part PL2 of the vehicle V that is suitable for projection into a zone Z2 allowing for access to a front passenger seat of the vehicle V, located beside the driver's seat.

In this case, the second mini-projector MP2 is installed on a right-hand side member of the vehicle V which is positioned beside the front passenger seat.

As a variant or in addition the projection means MPj may, as illustrated in a non-limiting manner in the single drawing, comprise a third mini-projector MP3 that is suitable for being installed in a rear part PR of the vehicle V that is suitable for projection into a rear zone Z3 allowing for access to an object storage space of the vehicle V. The object storage space may be a trunk or a rear loading compartment.

It will be noted that the projection means MPj may comprise any number of mini-projectors, as long as this number is at least equal to one. Therefore, the projection means may comprise just one mini-projector or two mini-projectors or even more than three mini-projectors (such as for example five if the vehicle comprises four side doors and a trunk lid or a tailgate). If the vehicle V comprises just one mini-projector the projector is preferably installed on the first side part PL1 which is located beside the driver's position, because the information to be provided in particular concerns the driver.

When a detected person CD is preparing to access the vehicle V, the control means MCT determines, from the information received by the communications module MCN from the wireless communications network RC, whether some of the information concerns the detected person. If this is the case, the control means MCT triggers the projection, by the projection means MPj, of at least one image IP onto the ground, in the immediate vicinity of at least one zone Zj that allows for access to the vehicle V, which image is representative of the information determined.

In this case, it is considered that a person has been detected when an item of equipment of the vehicle V has determined an item of information stored in an electronic access device DE carried by the person CD, which information is, moreover, known to the vehicle V and which allows access to the vehicle V, for example in order to unlock the vehicle-and/or to start the vehicle's engine. The person is therefore a user of the vehicle V. By way of example, the electronic access device DE may be an electronic access key (or “smart key” or “fob”) or a hands-free type electronic access card, or even a smartphone.

In the example illustrated in a non-limiting manner in the single drawing, a person CD has been detected in the vicinity of the zone Z1 located beside the left-hand door of the driver's position, and therefore the control means MCT triggers the projection, by the first mini-projector MP1, of an image IP representative of the information determined concerning the person CD, onto the ground in the zone Z1. This very advantageously makes it possible to alert the detected person CD to a problem or event concerning the person, before they access the vehicle V.

However, in a variant the control means MCT could be arranged so as to trigger the simultaneous projection of the same image IP in each of the zones Zk (in this case Z1 to Z3).

It will be noted that it is advantageous for the control means MCT to be arranged so as to determine information concerning the detected person that is likely to hinder or prevent driving of the vehicle V. Indeed, it will be understood that the aim is to alert the detected person CD of a risk, problem or event, and not to signal some kind of “normal” information to the person, i.e. is not capable of having the information reflected or reacting thereto with respect to the use of the vehicle V.

For example, the information determined by the control means MCT may be selected from road information, meteorological information, pollution information, a receipt of an electronic message, and a receipt of an audio message of a telephone voicemail.

Such information may be provided by information sites Sn (in this case n=1 or 2) that can be accessed via the wireless communications network RC. The information is for example obtained by the control means MCT on request, following the detection of the person CD. For example, a first site S1 (n=1) may provide road information and/or meteorological information and/or pollution information, and a second site S2 (n=2) may provide messages signaling the receipt of electronic messages and/or the receipt of audio messages of a telephone voicemail.

It will be understood that the road information, the meteorological information and the pollution information relate, more particularly, to the route that the vehicle V will take once the detected person CD is settled in the vehicle V, for example in the driver's seat. It is therefore preferable for the control means MCT to analyze the information received by the communications module MCN, in order to determine and signal via a projected image IP only that information that is likely to hinder or prevent driving of the vehicle V. This is in particular the case for information relating to the occurrence of heavy rain or black ice or fog or strong winds or a flooded region or polluted region, or snowfall, or an accident, or slow or stopped traffic, or a diversion, or even an alternate day vehicle use restriction that prevents particular vehicles from travelling at the time in question.

For example, if the vehicle V comprises a navigational aid that has been pre-programmed with a route (or itinerary), the control means MCT may provide only road information (including an alternative route) and/or meteorological information and/or pollution information that relates to the pre-programmed route that the vehicle V is preparing to take. This advantageously makes it possible to provide the driver CD only with information that is directly related to the route that he must take with his vehicle V, and to thus avoid his having to make a selection from the information provided to him via the projected images IP. Thus the driver CD can, for example, very quickly decide to change the time of his departure or to cancel his trip or to research a new itinerary, or even to change his means of transport.

Purely by way of purely illustrative example, in the single drawing the projected image IP signals that the vehicle V is forbidden from driving on the day in question due to an alternate day vehicle use restriction decided upon by the local authorities

Likewise, it is preferable for the control means MCT to signal, via a projected image IP, only the received messages that are of an urgent or very urgent nature. Thus the driver CD can, for example, very quickly decide to access the voicemail in question in order to analyze each message indicated, which may cause him to change the time of his departure or to cancel his trip or to research a new itinerary.

It will be understood that the received messages are those which concern the person CD for whom at least one communication identifier has previously been recorded in the vehicle V by the information provision device DF in connection with the information contained in the electronic access device DE.

It will also be noted that the control means MCT may trigger the projection of images of different types, i.e. containing a predefined text selected from a plurality of texts, or a non-predefined text, and/or a predefined drawing selected from a plurality of drawings.

It will be understood that the control means MCT are arranged so as to generate each data file defining an informational image IP to be projected, and so as to provide each file to each involved sub-portion of the projection means MPj.

It will also be noted that the control means MCT can be arranged so as to generate and trigger the projection of a plurality of successive images IP if the information that the control means wishes to provide to the detected person (or user) CD cannot be contained in a single image to be projected.

It will also be noted that the control means MCT may be arranged so as to trigger the projection of one or more images IP in the event of receipt of a dedicated general message by the detection means MDk of the vehicle V, in the event of detection of the person close to the vehicle V.

The detection means MDk comprises, for example, at least one transmitter/receiver that is capable of communicating with the electronic access device DE which is carried by the person CD, in particular in order to recover the information stored thereon. In the example illustrated in a non-limiting manner in the single drawing, the detection means MDk comprises as many transmitters/receivers as there are zones Zj in which images IP can be projected (therefore k=j). This arrangement is intended to allow for precise localization of the person CD with respect to each of the zones Zk. However, this is not obligatory. Indeed, the number of transmitters/receivers MDk can be of any value greater than or equal to one (1). Moreover, it is conceivable that the detection means MDk may also comprise at least one digital camera that is intended to allow the recognition of one or more different people, the photograph(s) of whom has/have been previously recorded in the information provision device DF. In a variant, the detection means MDk may also comprise at least one radar that is intended to detect the presence of a person in the surroundings of the vehicle V, in order to locate the person relative to the vehicle (V).

It will also be noted that, in the example illustrated in a non-limiting manner in the single drawing, the control means MCT is installed in a computer (or a microprocessor) CA which can optionally provide at least one other function within the vehicle V. The computer CA may, for example, be a telematic control unit (optionally a radio-frequency ancillary unit). However, this is not obligatory. Therefore, the control means MCT may be implemented in the form of software (or computing) modules, or a combination of electronic circuits (or hardware) and software modules.

1. A terrestrial motor vehicle comprising a communications module that is connected to a wireless communications network and an information provision device that comprises a communications module that is connected to the wireless communications network, said information provision device comprising projection means that is installed in at least a part (PLD of said vehicle (V) and is suitable for projecting at least one image onto the ground in a vicinity of said vehicle, said information provision device further comprising control means that determines, from road information, meteorological information, pollution information, a receipt of an electronic message, and a receipt of an audio message of a telephone voicemail, received by said communications module from said wireless communications network, when a detected person is preparing to access said vehicle, whether some of said information concerns said detected person and, if so, said control means triggers the projection, by said projection means (MPj), of at least one image representative of said determined information, onto the ground in the immediate vicinity of at least one zone (Zj) that allows for access to said vehicle (V).

2. The vehicle according to the claim 1, wherein said road and/or meteorological and/or pollution information relates to a pre-programmed route which said vehicle is preparing to take.

3. The vehicle according to claim 1, wherein said projection means comprises at least one first mini-projector that is suitable for being installed in a first side part of said vehicle that is suitable for projection into a zone allowing for access to a driver's position of said vehicle.

4. The vehicle according to claim 3, wherein said projection means comprises a second mini-projector that is suitable for being installed in a second side part of said vehicle that is suitable for projection into a zone allowing for access to a front passenger seat of said vehicle, and/or a third mini-projector that is suitable for being installed in a rear part of said vehicle that is suitable for projection into a rear zone allowing for access to an object storage space of the vehicle.

5. The vehicle according to claim 1, wherein said control means determines information likely to hinder or prevent driving of said vehicle.

6. The vehicle according to claim 1, wherein said control means triggers said projection in the event of receipt of a dedicated general message by the detection means of the vehicle, in the event of detection of said person being close to said vehicle.

7. The vehicle according to claim 1, wherein said vehicle comprises a rocker panel to which said projection means of the information provision device is secured.
